(19) United States
(12) Patent Application Publication
(10) Pub. No.: US 2026/0371207 A1
(43) Pub. Date: Nov. 19, 2026

(54) TERMINAL APPARATUS, BASE STATION APPARATUS, CONTROL METHOD OF TERMINAL APPARATUS, AND CONTROL METHOD OF BASE STATION APPARATUS

(71) Applicant: 1FINITY Inc., Kawasaki-shi (JP)

(72) Inventors: Katsunari UEMURA, Chiba (JP); Koichiro KITAGAWA, Yokohama (JP); TAEWOO LEE, Edogawa (JP)

(73) Assignee: 1FINITY Inc., Kawasaki-shi (JP)

(21) Appl. No.: 19/734,408

(22) Filed: Jul. 8, 2026

Related U.S. Application Data
(63) Continuation of application No. PCT/JP2024/005482, filed on Feb. 16, 2024.

(51) Int. Cl. H04W 36/30

(52) U.S. Cl. CPC H04W 36/304

(57) ABSTRACT

A terminal apparatus that communicates with a base station apparatus includes: a receiver configured to receive, from the base station apparatus, information related to a measurement configuration including a measurement event for measuring reception quality of a cell and configuration information related to use of a cell prediction result; a predictor configured to output a prediction of a variation in reception quality of the cell as a cell prediction result, and a transmitter configured to report each of the measurement event, first reception quality actually measured regarding the measurement event; and second reception quality based on the cell prediction result to the base station apparatus on a basis of information indicating permission to use the cell prediction result.

### CROSS-REFERENCE TO RELATED APPLICATION

This application is a continuation application of International Application Number PCT/JP2024/005482 filed on Feb. 16, 2024 and designated the U.S., the entire contents of which are incorporated herein by reference.

### FIELD

The present disclosure relates to a terminal apparatus, a base station apparatus, a control method of the terminal apparatus, and a control method of the base station apparatus.

### BACKGROUND

In the 3rd Generation Partnership Project (3GPP (registered trademark)) which is a standardization project, as New Radio (NR, also referred to as “5G”) which is fifth generation mobile communication, technical specifications of communication standards that satisfy requirements of Enhanced Mobile Broadband (eMBB), Massive Machine Type Communications (MTC), and Ultra-Reliable and Low Latency Communications (URLLC) are being studied.

In 3GPP, methods for optimizing signaling, report values, and the like by using artificial intelligence/machine learning (AI/ML) are being studied. Specifically, a technique has been studied in which a terminal apparatus or a network (that is, a base station apparatus, a core network apparatus, or the like) includes a learning model trained by machine learning (ML), which is an area of AI, and an output value obtained by inputting a predetermined input value to the trained learning model is used for substitution, complementation, verification, and the like of an actual measurement value (3GPP TR 38.843 V18.0.0 (2023-12)).

In addition, in 3GPP, mobility control (mobility) is to be studied using AI/ML. For example, by predicting (inferring) future quality of a cell by a trained learning model and determining in advance event evaluations such as handover on the basis of a predicted result, it is planned to perform a study for the purpose of higher performance and higher reliability of mobility control than before (RP-234055).

### SUMMARY

However, many parameters in related mobility control are determined by a network operator (base station apparatus) on the basis of an actual surrounding environment of a cell or a terminal apparatus, and are not designed to follow the quality of the cell predicted by the terminal apparatus. In addition, since the measurement event is determined on the basis of the actually measured measurement result of the cell, the case in which the measurement event is evaluated using a prediction value as in AI/ML is not assumed. For this reason, no specific solution has been mentioned so far to the problem that the performance of the related mobility control may be deteriorated when the reception quality (cell quality) of the cell is predicted by AI/ML and the prediction is simply used for the mobility control.

A terminal apparatus that communicates with a base station apparatus, the terminal apparatus includes, a receiver configured to receive, from the base station apparatus, information related to a measurement configuration including a measurement event for measuring reception quality of a cell and configuration information related to use of a cell prediction result, a predictor configured to output a prediction of a variation in reception quality of the cell as a cell prediction result, and a transmitter configured to report each of the measurement event, first reception quality actually measured regarding the measurement event, and second reception quality based on the cell prediction result to the base station apparatus on a basis of information indicating permission to use the cell prediction result.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a configuration of a radio communication system according to an embodiment.

FIG. 2 is a diagram illustrating an example of a functional configuration of a terminal apparatus according to the embodiment.

FIG. 3 is a diagram illustrating an example of a functional configuration of a base station apparatus according to the embodiment.

FIG. 4 is a diagram illustrating an example of reporting a prediction result of cell quality according to the embodiment.

FIG. 5 is a diagram illustrating another example of reporting a prediction result of cell quality according to the embodiment.

FIG. 6 is a diagram illustrating an example of a relationship between input data and output data of a trained model according to the embodiment.

FIG. 7 is a sequence diagram illustrating an example of an RRC message according to the embodiment.

FIG. 8 is a diagram illustrating a framework of AI/ML for an air interface.

FIG. 9 is a diagram illustrating an example of a hardware configuration of a terminal apparatus.

FIG. 10 is a diagram illustrating an example of a hardware configuration of a base station apparatus.

### DESCRIPTION OF EMBODIMENTS

Hereinafter, embodiments of the present disclosure will be described in detail with reference to the drawings. Problems and embodiments in the present specification are merely exemplary and do not limit the claims of the present application. Specifically, the technique of the present application can be applied as long as the expressions are technically equivalent even when the expressions are different, and the claims are not limited. Then, each embodiment can be appropriately combined within a range in which there is no contradiction in processing content. For example, an inactive period may be referred to as a non-active period.

A known technique may be appropriately used in a radio communication system according to the embodiments of the present disclosure. The applicable known technique may be, for example, 5G (NR), Beyond 5G, 5G-Advanced, 6G, or other radio communication methods. The radio communication system according to the embodiments of the present disclosure is mainly directed to NR, but is not limited thereto. For example, the embodiments of the present disclosure are applicable to Long Term Evolution (LTE) and LTE-Advanced. In addition, the embodiments are applicable to a radio communication system using NR as part of the radio communication system.

Further, the embodiments of the present disclosure are applicable to any radio communication system including at least a terminal apparatus and a base station apparatus, and are applicable to future radio communication systems. In the following description, LTE and LTE-Advanced are referred to as evolved universal terrestrial radio access (E-UTRA), and the meanings thereof are the same.

Hereinafter, embodiments of a base station apparatus, a terminal apparatus, and a radio communication system disclosed in the present application will be described with reference to the drawings. Note that the following embodiments do not limit the disclosed technique.

### Radio Communication System

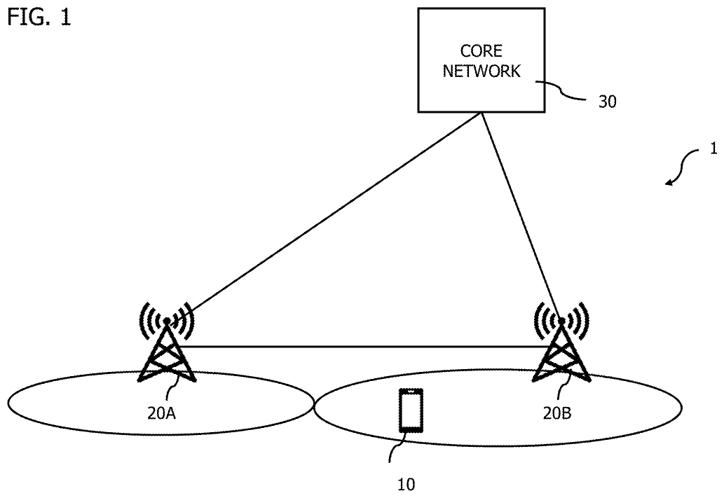

FIG. 1 is a diagram illustrating an example of a configuration of a radio communication system 1 according to an embodiment of the present disclosure. The radio communication system 1 according to the embodiment includes, for example, a terminal apparatus 10, base station apparatuses 20A and 20B, and a core network 30. Note that, in a case where the base station apparatuses 20A and 20B are not distinguished, they are simply referred to as a base station apparatus 20. Furthermore, a plurality of terminal apparatuses 10 may be provided.

The terminal apparatus 10 may be, for example, a radio terminal of various apparatuses and instruments (sensor apparatuses and the like) having a radio communication function, such as mobile phones, smartphones, personal digital assistants (PDAs), tablets, wearable terminals, personal computers, and vehicles. In addition, the terminal apparatus 10 may be referred to as a radio communication apparatus, a communication apparatus, a reception apparatus, a mobile station, user equipment (UE), a user apparatus, or the like.

A radio communication service is provided to the terminal apparatus 10 by the base station apparatus 20 and the core network 30 in the radio communication system 1. The core network 30 has functions such as management of service subscriber information, session management such as a voice call, and position registration management of the terminal apparatus 10, for example. Further, the core network 30 transmits control data and/or user data to the terminal apparatus 10 via the base station apparatus 20.

The core network 30 may be a 5G core (5GC) in 5G (NR) or an evolved packet core (EPC) in 4G (E-UTRA). In addition, a connection method between the core network 30 and the base station apparatus 20 may be a non-standalone (NSA) scheme or a standalone (SA) scheme.

A 5G base station apparatus 20 connected to the 5GC is a gNB, and a 4G base station apparatus 20 connected to the EPC is an eNB. In addition, 5G base station apparatuses are connected by an Xn interface, and 4G base station apparatuses are connected by an X2 interface.

An area (coverage area) formed by the base station apparatus 20 may be referred to as a “cell”. E-UTRA and 5G are cellular communication systems constructed by a plurality of cells. As the radio communication system according to the embodiment of the present disclosure, either a time division duplex (TDD) method or a frequency division duplex (FDD) method may be applied, or a different method may be applied for each cell.

The base station apparatus 20 may be configured to be divided into, for example, a centralized unit (CU), a distributed unit (DU), and a radio unit (RU). The CU is connected to the core network. In addition, the DU is connected to the terminal apparatus 10 via, for example, an RU. In this case, a communication path between the CU and the DU is realized by, for example, a fronthaul interface (F1 interface). In addition, a plurality of DUs may be connected to one CU. Part of the base station apparatus 20 may be configured by a program executable on a cloud network.

In the example illustrated in FIG. 1, data (DL data, downlink data) transmitted from the core network 30 to the terminal apparatus 10 is transmitted from the core network 30 to the base station apparatus 20, and is transmitted (transferred) from the base station apparatus 20 to the terminal apparatus 10.

Data (UL data and uplink data) transmitted from the terminal apparatus 10 to the core network 30 is transmitted from the terminal apparatus 10 to the base station apparatus 20, and is transmitted (transferred) from the base station apparatus 20 to the core network 30.

The terminal apparatus 10 and the base station apparatus 20 transmit and receive an RRC message (also referred to as RRC signaling) in a radio resource control (RRC) layer. In addition, the terminal apparatus 10 and the base station apparatus 20 transmit and receive, in a medium access control (MAC) layer, an MAC control element (MAC CE).

The RRC message is transmitted as a RRC protocol data unit (PDU), and a common control channel (CCCH), a dedicated control channel (DCCH), a paging control channel (PCCH), a broadcast control channel (BCCH), or a multicast control channel (MCCH) is used as a logical channel (LCH) to be mapped.

The MAC CE is transmitted as a MAC PDU (or a MAC subPDU). The MAC subPDU is equivalent to a service data unit (SDU) in the MAC layer with, for example, an 8-bit header added, and the MAC PDU includes one or more MAC subPDUs.

Subsequently, as the physical channel and the physical signal according to the embodiment, at least synchronization signals (a primary synchronization signal and a secondary synchronization signal), a physical broadcast channel (PBCH), a physical random access channel (PRACH), a physical downlink control channel (PDCCH), a channel state information-reference signal (CSI-RS), a physical uplink control channel (PUCCH), a physical downlink shared channel (PDSCH), a physical uplink shared channel (PUSCH), a scheduling reference signal (SRS), and a demodulation reference signal (DMRS) are present, but a detailed description thereof will be omitted.

### Terminal Apparatus

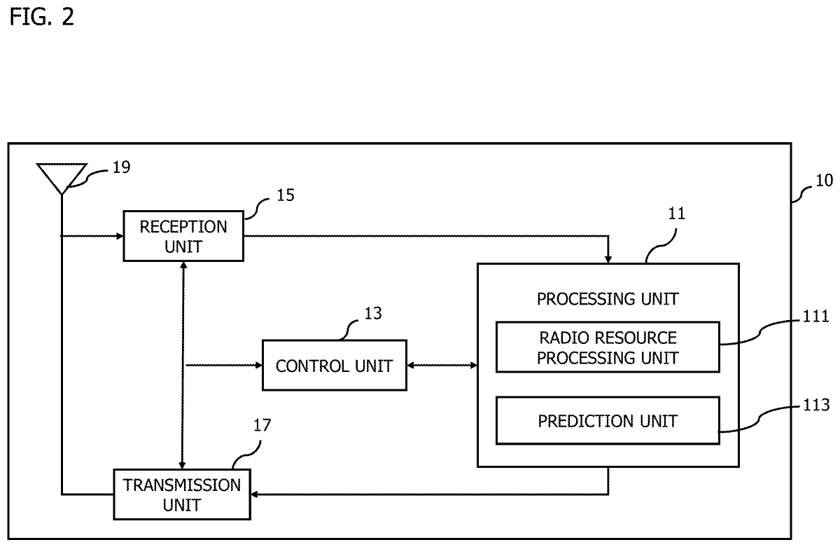

FIG. 2 is a diagram illustrating an example of a functional configuration of the terminal apparatus 10 according to the embodiment. As illustrated in FIG. 2, the terminal apparatus 10 includes, for example, a processing unit 11, a control unit 13, a reception unit 15, a transmission unit 17, and a transmission/reception antenna unit 19. The processing unit 11 includes, for example, a radio resource processing unit 111 and a prediction unit 113. Note that the functional configuration of the terminal apparatus 10 illustrated in FIG. 2 is merely an example, and the functional categories and the names of the functional blocks may differ as long as the operation according to the embodiment can be executed. In addition, there may be one or more blocks that realize other functions.

The processing unit 11 generates, for example, control information for controlling the reception unit 15 and the transmission unit 17, and outputs the control information to the control unit 13. The processing unit 11 executes processing regarding, for example, a radio resource control layer, a packet data convergence protocol (PDCP) layer, a radio link control (RLC) layer, and a medium access control layer.

The radio resource processing unit 111 manages various configuration information (RRC parameter, information element (IE)) of the terminal apparatus 10. For example, the radio resource processing unit 111 generates information disposed in each channel of the physical uplink, and outputs the information to the transmission unit 17. In addition, on the basis of an instruction from the base station apparatus 20, the radio resource processing unit 111 performs measurement of a serving cell and a neighboring cell, start and stop of transmission/reception processing, a DL synchronization procedure (cell search), a UL synchronization procedure (random access procedure), reacquisition of system information, event evaluation regarding mobility control, a series of processes regarding mobility control, and the like.

The prediction unit 113 includes at least one trained learning model (machine-trained machine learning model, hereinafter also referred to as a trained model), and performs the control process that functions to output a predetermined prediction value on the basis of input data. That is, the prediction unit 113 calculates and processes specific input information according to the intended use using the trained model, and outputs the results as a prediction value. The prediction unit 113 performs (executes) activation, deactivation, switching, fallback (stop of use of the trained model), and the like of the trained model on the basis of an instruction from the radio resource processing unit 111 or an instruction from the base station apparatus 20, and performs (executes) prediction of cell measurement and/or prediction of event evaluation.

The control unit 13 performs various kinds of control in the terminal apparatus 10. For example, the control unit 13 generates a control signal or control data for controlling the reception unit 15 and the transmission unit 17 on the basis of the control information from the processing unit 11. In addition, the control unit 13 controls uplink transmission to the base station apparatus 20, scheduling request transmission, and downlink reception from the base station apparatus 20 on the basis of the prediction result from the prediction unit 113.

On the basis of the control signal provided from the control unit 13, the reception unit 15 separates, demodulates, and decodes various signals received from the base station apparatus 20 via the transmission/reception antenna unit 19. The reception unit 15 outputs the decoded information to the processing unit 11.

On the basis of the control signal provided from the control unit 13, the transmission unit 17 generates, for example, a physical uplink signal, and encodes and modulates the physical uplink signal provided from the processing unit 11 or the physical uplink channel. The transmission unit 17 multiplexes various signals and transmits the multiplexed signals to the base station apparatus 20 via the transmission/reception antenna unit 19.

The processing unit 11 and the control unit 13 are realized by, for example, a processor system including a processor and a memory. In this case, the processor provides the functions of the processing unit 11 and the control unit 13 by executing a program describing the operation of the terminal apparatus 10 that will be described later. In addition, the processing unit 11 and the control unit 13 may be realized by one processor system or may be realized by a plurality of processor systems. Alternatively, the processing unit 11 and the control unit 13 may be realized by a digital signal processor (DSP), a hardware circuit, or the like.

### Base Station Apparatus

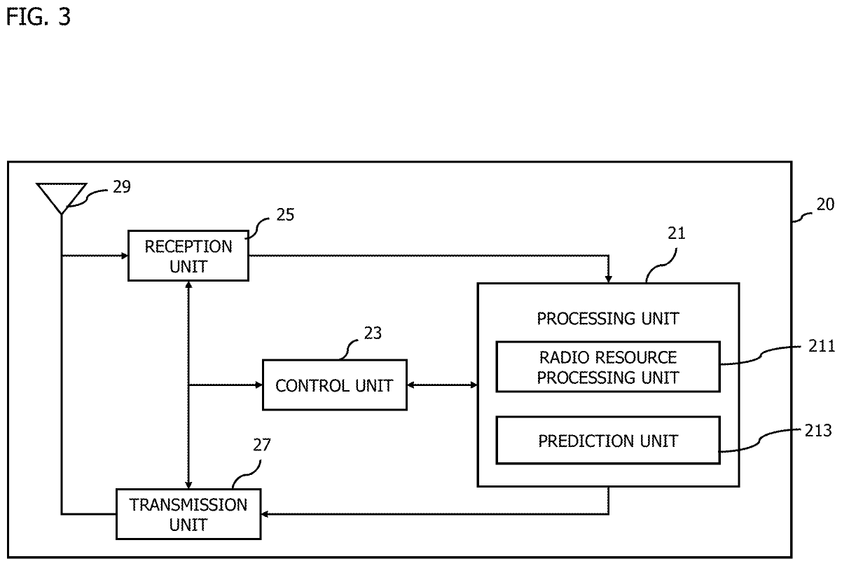

FIG. 3 is a diagram illustrating an example of a functional configuration of the base station apparatus 20 according to the embodiment. As illustrated in FIG. 3, the base station apparatus 20 includes, for example, a processing unit 21, a control unit 23, a reception unit 25, a transmission unit 27, and a transmission/reception antenna unit 29. The processing unit 21 includes, for example, a radio resource processing unit 211 and a prediction unit 213. Note that the functional configuration of the base station apparatus 20 illustrated in FIG. 3 is merely an example, and the functional categories and the names of the functional blocks may differ as long as the operation according to the embodiment can be executed. In addition, there may be one or more blocks that realize other functions.

The processing unit 21 generates, for example, control information for controlling the reception unit 25 and the transmission unit 27, and outputs the control information to the control unit 23. The processing unit 21 executes processing regarding, for example, a radio resource control layer, a packet data convergence protocol layer, a radio link control layer, and a medium access control layer.

The radio resource processing unit 211 generates, for example, downlink data, an RRC message, and a MAC control element that are disposed in a physical downlink shared channel PDSCH, and outputs the downlink data, the RRC message, and the MAC control element to the transmission unit 27. In addition, the radio resource processing unit 211 generates a control signal or control data which is disposed in a physical downlink control channel PDCCH, and outputs it to the transmission unit 27. Furthermore, the radio resource processing unit 211 manages various types of configuration information about the terminal apparatus 10. The radio resource processing unit 211 executes start and stop of transmission/reception processing, start of a UL synchronization procedure (random access procedure), update of system information, adjustment of a beam transmission angle, cell configuration regarding mobility control, pre-configuration of a parameter regarding a measurement event type (measurement event identifier), and the like on the basis of a notification using a signal or an RRC message from the terminal apparatus 10.

The prediction unit 213 performs a process of managing the prediction unit 113 of the terminal apparatus 10. The prediction unit 213 determines whether activation, deactivation, switching, and fallback of the trained model of the terminal apparatus 10 are necessary (important) on the basis of information related to mobility control such as information for determining a cell state, a reported prediction value, whether the prediction value is correct or incorrect, and an error of the prediction value, and determines whether to cause the terminal apparatus 10 to perform cell measurement prediction and/or event evaluation prediction.

The control unit 23 performs various kinds of control in the base station apparatus 20. For example, the control unit 23 generates a control signal or control data for controlling the reception unit 25 and the transmission unit 27 on the basis of the control information from the processing unit 21. Furthermore, the control unit 23 controls downlink transmission to the terminal apparatus 10 and uplink reception from the terminal apparatus 10 on the basis of determination information from the prediction unit 213.

The reception unit 25 separates, demodulates, and decodes various signals received from the terminal apparatus 10 or the core network 30 via the transmission/reception antenna unit 29 on the basis of the control signal provided from the control unit 23. The reception unit 25 outputs the decoded information to the processing unit 21.

The transmission unit 27 generates, for example, a downlink reference signal on the basis of the control signal provided from the control unit 23. The transmission unit 27 performs encoding, modulation, multiplexing, and the like on various types of information provided from the processing unit 21, thereby transmitting a signal to the terminal apparatus 10 via the transmission/reception antenna unit 29.

In addition, the transmission unit 27 transmits data to the terminal apparatus 10, another base station apparatus 20, or the core network 30. The reception unit 25 receives data from the terminal apparatus 10, another base station apparatus 20, or the core network 30.

Note that the processing unit 21 and the control unit 23 are realized by, for example, a processor system including a processor and a memory. In this case, the processor provides the functions of the processing unit 21 and the control unit 23 by executing a program describing the operation of the base station apparatus 20 that will be described later. In addition, the processing unit 21 and the control unit 23 may be realized by one processor system or may be realized by a plurality of processor systems. Alternatively, the processing unit 21 and the control unit 23 may be realized by a DSP, a hardware circuit, or the like.

### AI/ML for NR Air Interface

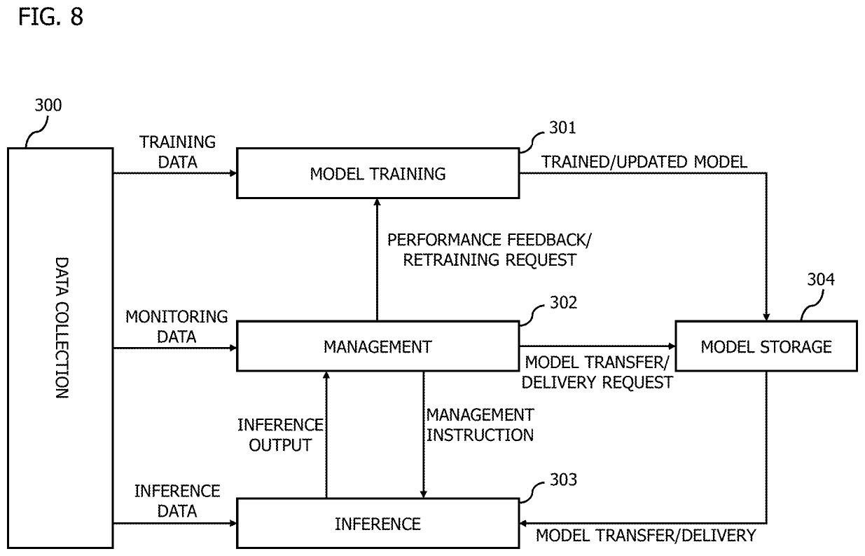

A framework of artificial intelligence (AI)/machine learning (ML) for an air interface studied in the 3GPP will be briefly described with reference to FIG. 8. The framework includes Data Collection (300), Model Training (301), Management (302), Inference (303), and Model Storage (304). The machine learning model generated and trained using the framework of FIG. 8 is referred to as an AI/ML model or simply a trained model.

Data Collection (300) has a function of collecting data, and a function of providing training data (Training Data) to Model Training (301), management data (Management Data) to Management (302), and inference data (Inference Data) to Inference (303).

Model Training (301) has a function of training, verifying, and testing an AI/ML model. In addition, Model Training may generate a performance index in a performance test procedure of the model. Furthermore, pre-processing, cleaning, formatting, and transformation of Training Data may be performed. Note that constructing the AI/ML model itself while training the AI/ML model may be referred to as learning (Leaning) for distinction, but in the present disclosure, it is referred to as Leaning without distinction. Model Training has a function of storing an AI/ML model subjected to training, verification, and testing, or an updated AI/ML model in Model Storage (304).

Management (302) has a function of performing execution management of activation, deactivation, switching, and fallback, and performing monitoring of the AI/ML model. Monitoring of the AI/ML model means performing performance monitoring for ensuring whether appropriate inference (prediction) is performed on the basis of data input from Data Collection and Inference. In other words, Management evaluates the degree of deviation between the output data of Inference and the correct data.

Management outputs, to Inference, information (Management Instruction) necessary (important) for function management of Inference (303). Management Instruction is, for example, a command indicating activation, deactivation, switching, and fallback of the AI/ML model. In addition, Management Instruction is for outputting a Model Transfer/Delivery Request to Model Storage (304) and requesting transfer/delivery of the AI/ML model. In addition, Management Instruction is for outputting a Performance Feedback/Retraining Request to Model Training (301), and training (retrains) or updating the AI/ML model is performed.

Inference (303) has a function of providing an output from a process to which the AI/ML model is applied in a case where inference data (Inference Data) provided from the Data Collection (300) is used as an input. Further, Inference (303) may perform pre-processing, cleaning, formatting, and transformation of the Inference Data. In addition, Inference (303) outputs, to Management, data (Inference Output) used in Management for monitoring the AI/ML model.

Model Storage (304) has a function of storing a trained/updated AI/ML model used in Inference. Model Storage (304) has a function (Model Transfer/Delivery) of delivering an AI/ML model to Inference (303).

Here, a method of generating a trained model performed in Model Training (301) may be any method, and for example, a trained model may be used in which data of a measurement value of a cell, a variation amount of a measurement value in a time unit, frequency information, a moving speed of a terminal, and the like are acquired as teacher data, and a measurement result (that is, the reception quality) of the cell after a lapse of a certain time is output as a prediction value using these pieces of teacher data. The trained model to be used may be generated by an apparatus (for example, the base station apparatus 20 or another external computing apparatus) other than the terminal apparatus 10 and transferred to the terminal apparatus 10. Furthermore, the learning algorithm applied to training, education, and reinforcement of the learning model may be any method as long as an expected output can be obtained, and may be, for example, a machine learning algorithm implemented using a convolutional neural network, a multilayer neural network, a deep neural network, or a distributed operation. The training method is preferably supervised training, but may be unsupervised training.

Note that some or all of the functions illustrated in FIG. 8 can be executed by the terminal apparatus 10, the base station apparatus 20, or another apparatus. That is, FIG. 8 illustrates an outline of each function and the relevance of each function with respect to the life cycle of the machine learning model, and does not impose any restriction on a place where the function is executed, and similarly does not impose any restriction on input and output of data.

### Measurement Configuration/Measurement Report

The base station apparatus 20 notifies (configures, designates, transmits) the terminal apparatus 10 of information about a measurement configuration to cause the terminal apparatus 10 to measure the frequency (for example, NR and/or EUTRA frequency). Note that the information about the measurement configuration is notified by, for example, an RRC message (for example, RRCReconfiguration). Note that the information about the measurement configuration may be described as the measurement configuration, and hereinafter, the information about the measurement configuration is described as the measurement configuration.

The measurement configuration comprises at least the following parameters:
(1) Measurement object(s)

The measurement object includes information about an object to be measured by the terminal apparatus 10, and a plurality of the measurement objects can be configured as a list format. The base station apparatus 20 may indicate intra-frequency measurements, inter-frequency measurements, and inter-radio access technology(RAT) E-UTRA measurements as measurement objects. In the case of inter-radio access technology(RAT) E-UTRA measurements, the EUTRA frequency is configured as a measurement object.

In addition, the base station apparatus 20 can include a list of cells to which a cell-specific offset is given, a block cell list, and an allowed cell list in the measurement object. The cell-specific offset is an offset value added to a measurement result at the time of measurement, the block cell list is a list indicating cells that are not applicable (excluded) as event evaluation (described later) or a measurement report, and the allowed cell list is a list indicating cells that are applicable (included) as event evaluation or a measurement report. In order to manage measurement objects, the base station apparatus 20 configures a measurement object identifier (measObjectId) for each measurement object.
(2) Reporting configuration(s)

The reporting configuration includes information related to a measurement report, and one or a plurality of reporting configurations as a list format is configured for each measurement object. In order to manage the reporting configuration, the base station apparatus 20 configures a reporting configuration identifier (reportConfigId) for each reporting configuration.
(3) Measurement identity(ies) (measurement identifier)

The measurement identifier (measId) is an identifier for linking (associating, relating) one measurement object identifier (measObjectId) and one reporting configuration identifier (reportConfigId). A plurality of measurement identifiers can be configured as a list format. A plurality of reporting configurations may be linked to one measurement object by the measurement identifier, or a plurality of measurement objects may be linked to the same reporting configuration. The measurement report including the measurement identifier is transmitted in order to report the measurement event satisfying the trigger condition to the base station apparatus 20.

With respect to a measurement object related to NR, the terminal apparatus 10 measures and reports a serving cell, a listed cell, and a detection cell. The listed cell is a cell included in the list notified from the base station apparatus 20. The detection cell indicates a cell detected by another terminal apparatus 10 voluntarily.

The measured cell quality (reception quality, measurement quality) is calculated by measuring a synchronization signal block (SSB) or a channel state information reference signal (CSI-RS). The cell quality can be expressed using any of reference signal received power (RSRP), reference signal received quality (RSRQ), received signal strength indicator (RSSI), signal to interference plus noise ratio (SINR), and path loss.

The measurement event(s) evaluated by the terminal apparatus 10 is designated by the base station apparatus 20. The measurement event is designated in a reporting configuration and is managed by an event identifier (eventId). In a case where the measurement event is triggered (fulfilled), the terminal apparatus 10 generates a measurement report message and transmits the measurement report message (Measurement Report) to the base station apparatus 20. The condition (measurement type) indicating the transmission trigger of the measurement report message is periodic report or event trigger report (Event triggered), and one of them is designated by the base station apparatus 20.

A measurement object cell (applicable cell) to be evaluated for each measurement event is determined in the measurement event. For example, the measurement object cell in the event A1 is a serving cell. In addition, the measurement object cell in the event A3 is a cell (adjacent cell) detected at the frequency of the measurement object linked to the reporting configuration including the event A3.

The terminal apparatus 10 starts (initiates) a measurement report procedure in a case where the measurement type is an event trigger report, the measurement result meets the condition indicated by the measurement event, and the measurement result continues to meet the condition for a subsequent predetermined time. In other words, the measurement report procedure is started in a case where the measurement result of the measurement object cell satisfies (fulfills) the measurement event corresponding to the event identifier designated in the reporting configuration included in the measurement configuration, and the measurement result continues to satisfy the measurement event for the predetermined time. At this time, the terminal apparatus 10 reports the measurement result of the cell corresponding to the measurement identifier that satisfies the measurement event.

Here, the reception quality of the serving cell is defined as Mp, the reception quality of the neighboring cell is defined as Mn, the frequency offset corresponding to the serving frequency is defined as Ofp, the frequency offset corresponding to the frequency of the neighboring cell is defined as Ofn, the cell-specific offset corresponding to the serving cell is defined as Ocp, the cell-specific offset corresponding to the neighboring cell is defined as Ocn, the event-specific offset value is defined as Off, the hysteresis value is defined as Hys, and the quality-based threshold value is defined as Thresh (Thresh1, Thresh2). The base station apparatus 20 transmits these parameters to the terminal apparatus 10 using the RRC message as part of the measurement configuration. Note that the base station apparatus configures, in the terminal apparatus 10, a parameter TTT (TimeToTrigger) indicating a length of a predetermined time related to fulfillment of the measurement event.

In a case where the measurement result of the cell after filtering (L3 filtering) for averaging/smoothing the measurement results satisfies Formula 1, the terminal apparatus 10 determines that the event fulfillment condition (entering condition) of the event A3 is satisfied. Similarly, in a case where the measurement result satisfies Formula 2, the terminal apparatus 10 determines that an event leaving condition of the event A3 is satisfied.

Mn+Ofn+Ocn−Hys>Mp+Ofp+Ocp+Off [Formula 1]

Mn+Ofn+Ocn+Hys<Mp+Ofp+Ocp+Off [Formula 2]

### Conditional Handover

The terminal apparatus 10 in a communication state moves between cells formed by the base station apparatus 20 using a handover or a conditional handover (CHO). In the conditional handover, the base station apparatus 20 notifies the terminal apparatus 10 in advance of cell configuration information designating a candidate cell (target cell) that is a handover destination and a trigger condition (measurement event type (measurement event, measurement report event)) for the handover (conditional handover). The measurement event (trigger condition) designated in the conditional handover configuration is referred to as an event condition (conditional event).

In this case, the base station apparatus 20 can configure eight candidate cells at the maximum (that is, eight candidate cells at the maximum are configured) for the terminal apparatus 10. The terminal apparatus 10 measures a serving cell and a neighboring cell. In addition, the terminal apparatus 10 evaluates the measurement event on the basis of the trigger condition reported from the base station apparatus 20. Hereinafter, configuration information about one or a plurality of cells and the trigger condition are collectively referred to as a conditional handover configuration. The conditional handover configuration includes candidate cells and other required (important) cell configurations and is designated in one or more list formats. Here, the measurement object cell is a candidate cell included in the conditional handover configuration, and is identified by a physical cell identifier (PCI). In other words, the terminal apparatus 10 considers a cell having the physical cell identifier designated in the RRC message (RRCReconfiguration) included in the conditional handover configuration as a measurement object cell.

The base station apparatus 20 and the terminal apparatus 10 identify and manage conditional handover configurations by a handover condition reconfiguration identifier (CondReconfigId). The base station apparatus 20 and the terminal apparatus 10 may add, delete, or change each conditional handover configuration corresponding to the handover condition reconfiguration identifier. In addition, the handover condition reconfiguration identifier (CondReconfigId) can designate the event condition by linking with the measurement identifier (measId) included in the measurement configuration.

In a case where the trigger condition is fulfilled (the conditional handover condition is continuously satisfied in the TTT section), the terminal apparatus 10 applies the cell configuration of the candidate cell corresponding to the event condition as the handover destination cell. That is, after the conditional handover has succeeded, the cell configuration corresponding to another cell is unnecessary (unimportant). Therefore, the terminal apparatus which has performed the successful conditional handover autonomously deletes the cell configuration corresponding to a cell other than the destination cell.

As another example of a conditional handover event, there are an event condition A3, an event condition A4 and an event condition A5, based on quality. The fulfillment condition and the leaving condition of the event condition A3 are the same as those of the event A3 of the corresponding measurement event, and the fulfillment condition and the leaving condition of the event condition A4 and the event condition A5 are the same as those of the corresponding event A4 and event A5, respectively.

Embodiments of the present disclosure will be described with reference to the drawings in consideration of the above-described points. In the description of the embodiment of the present disclosure, in a case where a specific description of known functions and configurations related to the embodiment of the present disclosure makes the gist of the embodiment of the present disclosure unclear, the detailed description thereof will be omitted.

### First Embodiment

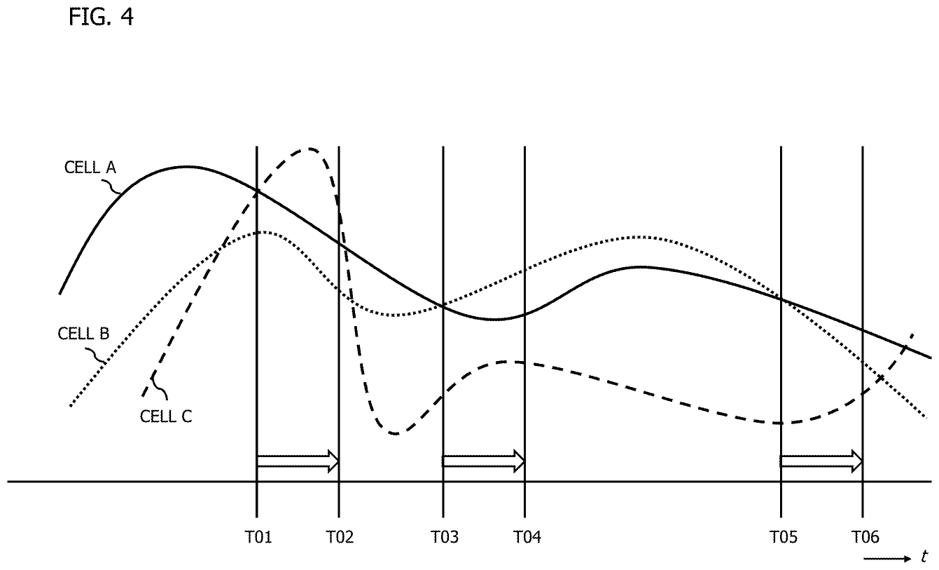

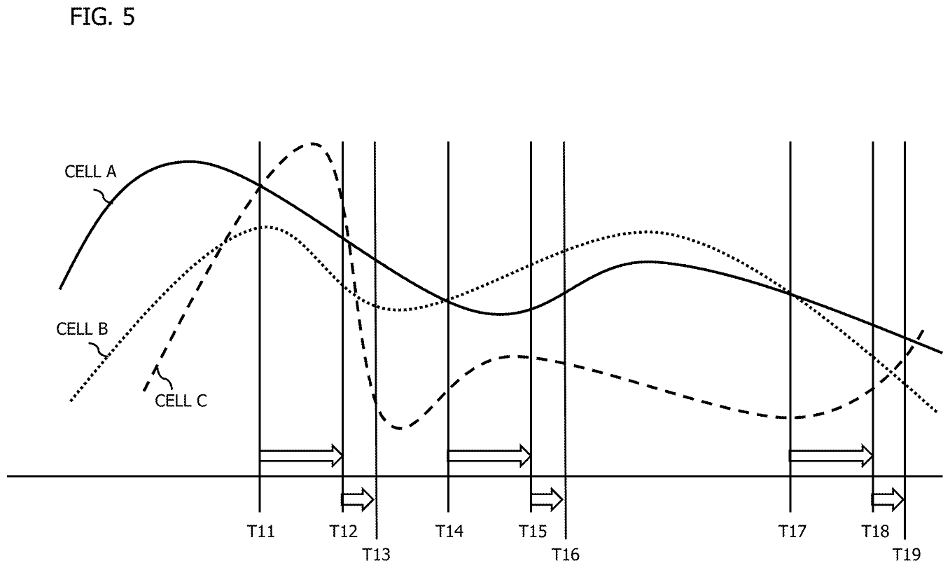

Each of FIGS. 4 to 5 is a diagram illustrating an example of the variation in the reception quality of the cell predicted by the prediction unit 113 of the terminal apparatus 10 according to the first embodiment and a correspondence relationship of the measurement report associated therewith. The horizontal axis represents a variation in time, and the vertical axis represents a variation in reception quality.

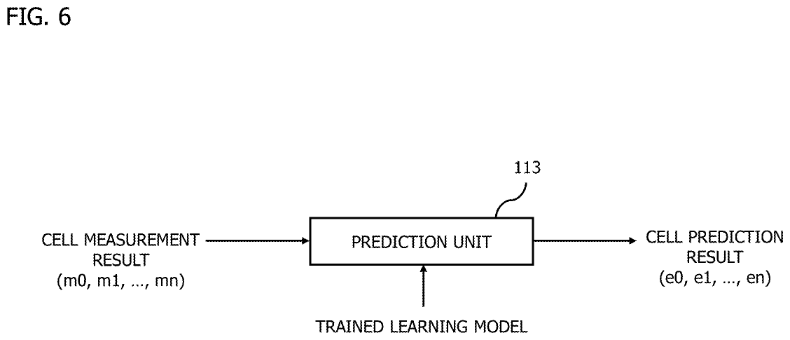

FIG. 6 is a diagram illustrating an example of a relationship between the prediction unit 113 of the terminal apparatus 10 and input data and output data of a trained model executed by the prediction unit 113. A trained learning model (trained model) is input to the prediction unit 113. The trained model to be input may be selected and configured (notified, designated) by the base station apparatus 20, or may be autonomously selected by the terminal apparatus 10. At this time, a plurality of trained models may be selected, or one suitable trained model may be selected. In a case where the trained model has already been selected, the prediction unit 113 may exchange (switch) the trained model.

In addition, the terminal apparatus 10 activates/deactivates the trained model. The activation/deactivation of the trained model may be selected and configured (notified, designated) by the base station apparatus 20, or may be autonomously selected by the terminal apparatus 10. The terminal apparatus 10 and the base station apparatus 20 may manage the trained models by allocating model identifiers (model IDs) to the respective trained models. The terminal apparatus 10 may use another trained model for each measurement event and/or each measurement quantity (RSRP, RSRQ, etc.). The base station apparatus 20 may instruct the terminal apparatus 10 to use another trained model for each measurement event and/or each measurement quantity (RSRP, RSRQ, etc.).

Data (cell measurement result) indicating the reception quality of the cell measured by the terminal apparatus 10 is input to the prediction unit 113. In addition, the trained model that is activated in the prediction unit 113 and is in operation outputs data (cell prediction result) indicating a prediction value of a variation in reception quality after a predetermined time (for example, time t) has elapsed with respect to each of the reception qualities of the input cell. For example, in a case where the measurement results corresponding to the cell 0, the cell 1, . . . , and the cell n (n is a natural number) are m0, m1, . . . , and mn, the output prediction values are e0, e1, . . . , and en. The prediction value may be a signed difference value from the input indicating the degree of variation in the reception quality of the cell, an absolute value of the same measurement quantity, or an absolute value of a measurement quantity different from the prediction value. For example, RSRP may be input as the reception quality of the cell, and the prediction value of RSRQ may be output as the output.

As described above, the output prediction value is the reception quality of each cell after each time t of the input values. Here, time t may be the TTT configured for the measurement event, may be a time designated by the base station apparatus 20, or may be a uniquely determined fixed value (for example, 100 microseconds). Alternatively, time t may be scaled at the speed of the terminal apparatus 10 or may be a different value for each cell. Furthermore, by designating a plurality of values, a plurality of prediction values having different prediction times may be output for one input.

The terminal apparatus 10 in FIGS. 4 to 5 measures a plurality of cells (cell A, cell B, cell C) belonging to one or a plurality of base station apparatuses 20. FIGS. 4 to 5 illustrate an example in which the cell measurement result in the terminal apparatus 10 is input to the trained model, and the temporal variation of the cell prediction result that is the output result is illustrated. The trained model used by the terminal apparatus 10 is generated by, for example, information about a physical cell ID as teacher data, a variation in reception quality of a plurality of cells, frequency information about a cell to be measured, a moving speed of the terminal apparatus 10, position information about the terminal apparatus 10 and the base station apparatus 20, a physical cell ID that is non line of sight, transmission power of the base station apparatus 20, weather, an interference amount between the terminal apparatuses 10, and the like. The trained model outputs the input reception quality of a cell after a lapse of a predetermined time or a variation amount of the reception quality by inputting the reception quality of the cell.

At the start time of FIGS. 4 and 5, the terminal apparatus 10 is in a connected mode (connected state), and communicates with the base station apparatus 20 using the cell A as a serving cell. The cell B and the cell C are cells to be measured as neighboring cells. In addition, the base station apparatus 20 configures, in the terminal apparatus 10, a configuration for evaluating the measurement event for the cell B or the cell C as the measurement configuration. As the measurement event, the event A3 for comparing the reception quality of at least the serving cell and the neighboring cell is configured.

The terminal apparatus 10 in FIG. 4 is instructed by the base station apparatus 20 as to whether to perform the event evaluation using the cell prediction result that is the output of the trained model. In other words, the base station apparatus 20 instructs the terminal apparatus 10 as to whether to activate the trained model and trigger the measurement event using the output cell prediction result. The base station apparatus 20 determines the presence or absence of the event evaluation using the result of the cell prediction by the terminal apparatus 10 on the basis of the received UE Capability message of the terminal apparatus 10.

By using the cell prediction result acquired from the trained model, the terminal apparatus 10 can make a notification of the evaluation result of the measurement event before actually measuring the cell and can prevent the failure of the handover due to the delay or the failure of the measurement event report related to the handover, and it is expected that the handover success rate is improved. The base station apparatus 20 can obtain the report of the fulfillment of the measurement event based on the cell prediction result earlier than actual, and the report of the future cell prediction result enables accurate determination as to whether handover is performed, and it is expected that the handover success rate is improved.

In a case where the cell prediction result is used, when reporting the fulfilled measurement event to the base station apparatus 20, the terminal apparatus 10 adds information indicating whether the measurement event is reported using the cell prediction result and performs reporting (transmission). For example, the terminal apparatus 10 may transmit a measurement report message different from that of the related art, may add a 1-bit identifier to the measurement report message, or may add another piece of identifiable information to perform reporting.

For example, in addition to the actually measured reception quality (first reception quality, cell measurement result) of the cell, the terminal apparatus 10 may add the predicted reception quality (second reception quality, cell prediction result) of the cell to the measurement report message and report the measurement report message. The added predicted reception quality of the cell is any one of the measurement object cell, the serving cell, and the neighboring cell of the measurement event, or a combination thereof. Alternatively, cell information to be predicted (for example, a physical cell ID) may be designated from the base station apparatus 20. The predicted reception quality of the cell is the reception quality of the cell after a predetermined time has elapsed from the current time. The predetermined time may be the same time as the TTT configured in the measurement event, or may be a value designated by the base station apparatus 20.

Time T01 indicates a time at which the reception quality of the cell A is lower than the reception quality of the cell C on the basis of the cell prediction result. In other words, the time indicates a time at which the event fulfillment condition (entering condition) of the event A3 is satisfied for the cell C. Note that it is assumed that various parameters used for evaluation of a measurement event, such as a frequency offset, a cell-specific offset, an event-specific offset value, and a hysteresis value notified in measurement configuration, are considered for each reception quality.

Time T02 indicates a time at which the terminal apparatus 10 determines that the event fulfillment condition for the event A3 is continuously satisfied for a predetermined time from time T01. That is, the time means that, as the output of the trained model, the cell prediction result of the cell C exceeds the cell prediction result of the cell A from time T01 to time T02, and the terminal apparatus 10 predicts that the event A3 is fulfilled for the cell C. The predetermined time may be, for example, TTT or may be based on information indicating a time length designated by the base station apparatus 20. Here, in a case where the terminal apparatus 10 at time T01 can output (predict) the reception quality of each cell at time T02 using the trained model, the corresponding measurement event is triggered at time T01 without waiting for time T02, and the measurement report message is transmitted to the base station apparatus 20.

At this time, in a case where the reception quality of the cell after time T02 is predicted from the output result of the trained model, the terminal apparatus 10 may transmit the measurement report message including additional prediction information about the reception quality of the cell. The additional prediction information is, for example, information indicating that handover of the source cell (cell A) may occur again after handover to the target cell (cell C) (so-called ping-pong), information indicating whether there is a possibility of handover failure or a magnitude of the possibility of handover failure, information indicating a time when an event leaving condition of the target cell is satisfied, information indicating a predicted stay time of the target cell after handover, and the like. The base station apparatus 20 may individually configure, in the terminal apparatus 10, which prediction information is additionally reported.

Furthermore, the terminal apparatus 10 evaluates the degree of deviation between the prediction value and the actual measurement value, and verifies the prediction accuracy. As a result, in a case where it is determined that the prediction value included in the measurement report message (first measurement report message) transmitted at time T01 is incorrect (the deviation of the prediction value falls within the allowable range), the measurement report message (second measurement report message) based on the actual measurement result may be transmitted. At this time, the terminal apparatus 10 transmits the second measurement report message including at least the measurement result of the same cell ID as the measurement identifier reported in the first measurement report message.

The deviation of the prediction value may be determined in a case where the difference between the prediction value and the actual measurement value is equal to or larger than a certain threshold value, or in a case where the accumulation of the difference between the prediction value and the actual measurement value is equal to or larger than a certain threshold value. The threshold value at this time may be configured as an evaluation parameter to the terminal apparatus 10 in advance by the base station apparatus 20. In a case where it is determined that the prediction value included in the measurement report message transmitted at time T01 is correct (the deviation of the prediction value is out of the allowable range), the terminal apparatus 10 does nothing in particular and continues the determination based on the prediction.

The terminal apparatus 10 may constantly monitor the prediction value, and may transmit the second measurement report message when it is determined that the prediction value is not correct, may make a determination every time the measurement report message is transmitted, or may make a determination on the basis of information configured from the base station apparatus 20. For example, the terminal apparatus 10 may periodically transmit the second measurement report message according to a configured time interval, may transmit the second measurement report message on the basis of the number of times the first measurement report message is transmitted (for example, transmit the second measurement report message after transmitting the first measurement report message n times (n is a value designated from the base station apparatus 20)), or may aperiodically transmit the second measurement report message on the basis of an instruction from the base station apparatus 20.

The aperiodic instruction from the base station apparatus 20 may be notified by the downlink control information included in the L1 signaling (PDCCH), may be notified by the MAC control element, or may be notified by an individual or common RRC message.

The time T03 indicates a time at which the reception quality of the cell A is lower than the reception quality of the cell B on the basis of the cell prediction result. In other words, the time indicates a time at which the event fulfillment condition (entering condition) of the event A3 is satisfied for the cell B. Furthermore, time T04 indicates a time at which the terminal apparatus 10 determines that the event fulfillment condition for the event A3 is continuously satisfied for a predetermined time from time T03. That is, the output of the trained model means that the cell prediction result of the cell B exceeds the cell prediction result of the cell A from time T03 to time T04, and the terminal apparatus 10 predicts that the event A3 is fulfilled for the cell B.

At this time, in a case where the reception quality of the cell after time T04 is predicted from the output result of the trained model, the terminal apparatus 10 may transmit the measurement report message including additional prediction information about the reception quality of the cell. The additional prediction information may be the same as that described above. Alternatively, as illustrated in FIG. 4, in a case where the predicted stay time after handover to the cell B continues for a certain period of time, the terminal apparatus 10 may not (does not) transmit additional prediction information.

A period from time T04 to time T05 indicates a state in which the serving cell of the terminal apparatus 10 is the cell B and the neighboring cells are the cell A and the cell C. The time T05 indicates a time at which the reception quality of the cell B is lower than the reception quality of the cell A on the basis of the cell prediction result. In other words, the time indicates a time at which the event fulfillment condition (entering condition) of the event A3 is satisfied for the cell A. Furthermore, time T06 indicates a time at which the terminal apparatus 10 determines that the event fulfillment condition for the event A3 is continuously satisfied for a predetermined time from time T05. That is, the time means that, as the output of the trained model, the cell prediction result of the cell A exceeds the cell prediction result of the cell B from time T05 to time T06, and the terminal apparatus 10 predicts that the event A3 is fulfilled for the cell A.

At this time, in a case where the reception quality of the cell after time T06 is predicted from the output result of the trained model, the terminal apparatus 10 may transmit the measurement report message including additional prediction information about the reception quality of the cell. The additional prediction information may be the same as that described above. Further, as illustrated in FIG. 4, information indicating that the reception quality of another neighboring cell (cell C) exceeds that of the target cell after handover to the target cell (cell A), information indicating a prediction time at which the reception quality of another neighboring cell (cell C) exceeds that of the target cell, information indicating a prediction time at which the reception quality of another neighboring cell (cell C) exceeds the reception quality of the source cell (cell B), and the like may be transmitted as additional prediction information.

FIG. 5 is different from FIG. 4 in that the terminal apparatus 10 is instructed by the base station apparatus 20 as to whether the cell prediction result may be additionally reported for the measurement event to be reported. In other words, the base station apparatus 20 instructs the terminal apparatus 10 to perform the event evaluation on the basis of the actually measured reception quality of the cell and activate the trained model, and instructs the terminal apparatus 10 as to whether to add the output cell prediction result at the time of reporting the measurement event. The base station apparatus 20 determines whether the result of the cell prediction by the terminal apparatus 10 has been reported on the basis of the received UE Capability message of the terminal apparatus 10.

By making a notification of the cell prediction result acquired from the trained model, the terminal apparatus 10 can cause the base station apparatus 20 to perform appropriate mobility control, and the handover success rate is expected to be improved. The base station apparatus 20 receives the determination information that can be used for mobility control of the base station apparatus 20 from the terminal apparatus 10 in addition to the report of fulfillment of the measurement event, so that it is possible to accurately determine whether handover is performed, and it is expected that the handover success rate is improved.

The terminal apparatus 10 reports, by adding the predicted reception quality of the cell to the measurement report message, the measurement report message in addition to the actually measured reception quality of the cell. The added predicted reception quality of the cell is any one of the measurement object cell, the serving cell, and the neighboring cell of the measurement event, or a combination thereof. The predicted reception quality of the cell is the reception quality of the cell after a predetermined time has elapsed from the current time. The predetermined time may be the same time as the TTT configured in the measurement event, or may be based on information indicating a time length designated by the base station apparatus 20.

Time T11 indicates a time when the reception quality of the cell A is lower than the reception quality of the cell C on the basis of the actually measured reception quality of the cell. In other words, the time indicates a time at which the event fulfillment condition (entering condition) of the event A3 is satisfied for the cell C. Note that it is assumed that various parameters used for evaluation of a measurement event, such as a frequency offset, a cell-specific offset, an event-specific offset value, and a hysteresis value notified in measurement configuration, are considered for each reception quality.

Time T12 indicates a time at which the terminal apparatus 10 determines that the event fulfillment condition for the event A3 is continuously satisfied for a predetermined time from time T11. That is, the time means that the reception quality of the cell C exceeds the reception quality of the cell A from time T11 to time T12, and the terminal apparatus 10 determines that the event A3 is fulfilled for the cell C. The predetermined time is, for example, TTT.

Here, in a case where the terminal apparatus 10 at the time point of time T12 can output (predict) the reception quality of each cell at time T13 using the trained model, the terminal apparatus 10 transmits, to the base station apparatus 20, the measurement report message triggered and reported at time T12 including the cell prediction result at time T13. A time interval (for example, time t2) from time T12 to time T13 may be, for example, TTT, or may be based on information indicating a time length designated by the base station apparatus 20. For the added cell prediction result, the predicted value may be reported as it is, a difference value from the reported reception quality of the cell may be calculated and reported, a result of another detected neighboring cell having a certain quality or more may be reported, or granularity information indicating an error range of the cell prediction result in addition to the above may be included and reported.

Alternatively, in a case where the reception quality of the cell after time T12 is predicted from the output result of the trained model, the terminal apparatus 10 may transmit the measurement report message including additional prediction information about the reception quality of the cell. The additional prediction information is, for example, information indicating that handover of the source cell (cell A) may occur again after handover to the target cell (cell C) (so-called ping-pong), information indicating whether there is a possibility of handover failure or a magnitude of the possibility of handover failure, information indicating a time when an event leaving condition of the target cell is satisfied, information indicating a predicted stay time of the target cell after handover, and the like. The base station apparatus 20 may individually configure, in the terminal apparatus 10, which prediction information is additionally reported.

Further, the terminal apparatus 10 may determine that the measurement report message based on the actual measurement result should not be (is not) transmitted on the basis of the prediction value predicted at time T13. The determination of transmitting the measurement report message may be based on the foregoing additional prediction information. In a case where the additional prediction information is used, threshold value information (such as a threshold value indicating time or a ratio) used for determination is configured in the terminal apparatus 10 by the base station apparatus 20. In a case where it is determined that the measurement report message should not be (is not) transmitted, the terminal apparatus 10 may cancel transmission of the measurement report message, suppress transmission of the measurement report message, suspend a measurement identifier corresponding to the measurement event, stop evaluation of a reporting configuration corresponding to the measurement event, or consider that the measurement event does not meet (does not trigger) an event fulfillment condition.

The terminal apparatus 10 may constantly monitor the prediction value, and transmit a measurement report message based on an actual measurement result when it is determined that the prediction value is not correct. The determination of whether the prediction value is correct or incorrect may be the same as the above-described method. In a case where the measurement report message has not been transmitted on the basis of the determination on the transmission of the measurement report message, information about the time in a case where the measurement event is actually fulfilled or the reception quality of the cell may be further included. In addition, the terminal apparatus 10 may transmit information indicating that the prediction value is determined to be incorrect to the base station apparatus 20.

The terminal apparatus 10 that has determined not to transmit the measurement report message reports the information about the unreported measurement event to the base station apparatus 20. For example, the terminal apparatus 10 may use a UE assistance information message which is an RRC message. The information included in the RRC message may include, in addition to the information indicating non-reporting, information about a measurement event (measurement identifier), information about a time when the measurement event is actually fulfilled, reception quality of a cell, or a determination reason for determining that the message is not transmitted.

Time T14 indicates a time at which the reception quality of the cell A is lower than the reception quality of the cell B on the basis of the actually measured reception quality of the cell. In other words, the time indicates a time at which the event fulfillment condition (entering condition) of the event A3 is satisfied for the cell B. Furthermore, time T15 indicates a timing at which the terminal apparatus 10 determines that the event fulfillment condition for the event A3 is continuously satisfied for a predetermined time from time T14. That is, the time means that the reception quality of the cell B exceeds the reception quality of the cell A from time T14 to time T15, and the terminal apparatus 10 determines that the event A3 is fulfilled for the cell B. The predetermined time is, for example, TTT.

Here, in a case where the terminal apparatus 10 at the time point of time T15 can output (predict) the reception quality of each cell at time T16 using the trained model, the terminal apparatus 10 transmits, to the base station apparatus 20, the measurement report message triggered and reported at time T15 including the cell prediction result at time T16. A time interval (for example, time t2) from time T15 to time T16 may be, for example, TTT, or may be based on information indicating a time length designated by the base station apparatus 20. The added cell prediction result may be the same as that described above.

In a case where the prediction value included in the measurement report message transmitted at time T15 is correct, the terminal apparatus 10 does nothing in particular and continues determination based on the prediction. As illustrated in FIG. 5, in a case where the predicted stay time after the handover to the cell B continues for a certain period of time (for example, until time T16), the terminal apparatus 10 may stop the determination on whether the prediction value included in the measurement report message is correct or incorrect, and restart the normal operation.

A period from time T16 to time T17 indicates a state in which the serving cell of the terminal apparatus 10 is the cell B and the neighboring cells are the cell A and the cell C. Time T17 indicates a time at which the reception quality of the cell B is lower than the reception quality of the cell A. In other words, the time indicates a time at which the event fulfillment condition (entering condition) of the event A3 is satisfied for the cell A. Furthermore, time T18 indicates a timing at which the terminal apparatus 10 determines that the event fulfillment condition for the event A3 is continuously satisfied for a predetermined time from time T16. That is, the time means that the reception quality of the cell A exceeds the reception quality of the cell B from time T17 to time T18, and the terminal apparatus 10 determines that the event A3 is fulfilled for the cell A.

Here, in a case where the terminal apparatus 10 at the time point of time T18 can output (predict) the reception quality of each cell at time T19 using the trained model, the terminal apparatus 10 may transmit, to the base station apparatus 20, the measurement report message triggered and reported at time T18 including the cell prediction result at time T19 or further additional prediction information. The additional prediction information may be the same as that described above. Further, as illustrated in FIG. 5, information indicating that the reception quality of another neighboring cell (cell C) exceeds that of the target cell after handover to the target cell (cell A), information indicating a prediction time at which the reception quality of another neighboring cell (cell C) exceeds that of the target cell, information indicating a prediction time at which the reception quality of another neighboring cell (cell C) exceeds the reception quality of the source cell (cell B), a cell ID (cell C at time T19) recommended as the target cell, and the like may be transmitted as additional prediction information.

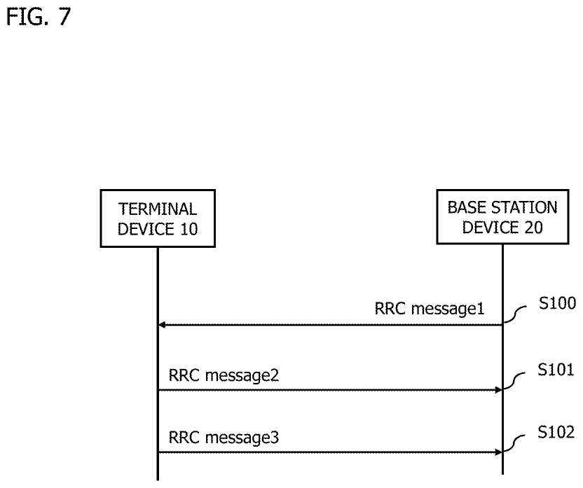

FIG. 7 is a sequence diagram for describing an example of an RRC message exchanged between the terminal apparatus 10 and the base station apparatus 20. Note that, although not illustrated, the processing starts from a state in which a radio connection (RRC setup) procedure between the terminal apparatus 10 and the base station apparatus 20 is completed and the state of the terminal apparatus 10 is shifted to an in-communication state (also referred to as a connected state or an RRC connected state). In addition, it is assumed that the terminal apparatus 10 generates an RRC message (UE Capability message) and transmits the RRC message to the base station apparatus 20 in order to notify the base station apparatus 20 of the radio capability of the terminal apparatus 10.

The terminal apparatus 10 may transmit the UE Capability message including information such as the position information accuracy (positioning support information) of the terminal apparatus 10, information indicating the predictable maximum time in a case where the trained model is used, and the predictable maximum number of cells.

The base station apparatus 20 transmits the first RRC message (RRC message1 in the drawing) to the terminal apparatus 10 (step S100). As the first RRC message, for example, a dedicated RRC message such as an RRCReconfiguration message is used. The first RRC message including the measurement configuration for configuring the measurement event is transmitted to the terminal apparatus 10. In addition, the first RRC message may include a trained model configuration instructing activation, deactivation, switching, and fallback of a trained model used by the terminal apparatus 10. In a case of instructing activation, deactivation, and switching of the trained model, the base station apparatus 20 makes a notification of an identifier (model ID) of a target trained model. The base station apparatus 20 may instruct activation or deactivation simultaneously with switching of the trained model.

The terminal apparatus 10 transmits a second RRC message (RRC message2 in the drawing) to the base station apparatus 20 in response to the first RRC message (step S101). The second RRC message is, for example, an RRCReconfigurationComplete message. The second RRC message is used to make a notification that the activation, the deactivation, the switching, and the fallback of the trained model designated by the base station apparatus 20 are normally completed.

The terminal apparatus 10 in which the measurement configuration is configured and the trained model is activated transmits the third RRC message (RRC message3 in the figure) to the base station apparatus 20 on the basis of the measurement configuration (step S102). The third RRC message is, for example, a measurement report message. In the terminal apparatus 10, the transmission timing of the third RRC message and the information included in the third RRC message are similar to those of the content described in FIGS. 4 to 5.

Alternatively, the terminal apparatus 10 and the base station apparatus 20 may be configured to operate by combining the operations in FIGS. 4 and 5. For example, the operation of FIG. 4 (that is, the measurement event is evaluated using the cell prediction result) may be performed in a case of determining the event fulfillment condition, and the operation of FIG. 5 (that is, the measurement event is evaluated using the cell measurement result, and the cell prediction result is added to the report) may be performed in a case of determining the event leaving condition, or vice versa. Alternatively, the operation of FIG. 4 may be normally continued, and in a case where it is determined that the cell prediction result is not correct, the operation may be switched to the operation of FIG. 5. That is, in a case where it is determined that the accuracy of the output of the trained model being used is low, the terminal apparatus 10 and the base station apparatus 20 fall back to the related operation using the actual cell measurement value for the evaluation of the measurement event.

Alternatively, which operation is performed may be explicitly designated by an RRC message from the base station apparatus 20, or the operation may be configured to be switched by downlink control information or a MAC control element included in L1 signaling (PDCCH).

As described above, according to the first embodiment, the terminal apparatus 10 and the base station apparatus 20 predict the reception quality of the cell using the trained model, and transmit and receive the measurement report message including the prediction result of the reception quality of the cell, whereby the performance of the mobility control between the terminal apparatus 10 and the base station apparatus 20 can be improved.

### Second Embodiment

The second embodiment will be described. Note that description of configurations, functions, or procedures common to the first embodiment and the second embodiment will be omitted. That is, points different from the first embodiment will be mainly described below.

The terminal apparatus 10 and the base station apparatus 20 according to the second embodiment use a cell prediction result that is an output of a trained model for evaluation of a measurement event (event condition (Conditional Event)) used for triggering the conditional handover (CHO). The terminal apparatus 10 is instructed by the base station apparatus 20 as to whether to evaluate the event condition using the cell prediction result that is the output of the trained model. In other words, the base station apparatus 20 instructs the terminal apparatus 10 as to whether to activate the trained model and execute the conditional handover using the output cell prediction result. The base station apparatus 20 determines whether the event condition is evaluated using the result of the cell prediction by the terminal apparatus 10 on the basis of the received UE Capability message of the terminal apparatus 10.

Note that the base station apparatus 20 may instruct the terminal apparatus 10 as to whether to execute one or both of (1) evaluation of a measurement event using a cell prediction result and (2) evaluation of an event condition using a cell prediction result. The instruction method may use the downlink control information included in the L1 signaling (PDCCH), may use the MAC control element, or may use an individual or common RRC message.

By using the cell prediction result acquired from the trained model, the terminal apparatus 10 can evaluate the event condition before actually measuring the cell, and the conditional handover success rate is expected to be improved. In addition, the terminal apparatus 10 can accurately determine whether the conditional handover is performed, and an improvement in the conditional handover success rate and a decrease in the frequency of occurrence of the radio link failure after the conditional handover are expected.

For example, the terminal apparatus 10 evaluates the event condition using the reception quality (cell prediction result) of the target cell after a predetermined time has elapsed from the current time, and performs the conditional handover to the target cell in a case where the event condition configured on the basis of the cell prediction result is fulfilled. The predetermined time may be the same time as the TTT configured in the measurement event, or may be a value designated by the base station apparatus 20.

In a case where the conditional handover is performed using the cell prediction result, the terminal apparatus 10 reports (transmits) information indicating whether the cell prediction result is used to the base station apparatus 20. For example, the terminal apparatus 10 may add information indicating whether the cell prediction result is used to the RRC message (RRCReconfigurationComplete) making a notification of the completion of execution of the conditional handover.

Alternatively, the terminal apparatus 10 may evaluate the event condition on the basis of the actually measured reception quality (first reception quality, cell measurement result) of the target cell, and determine whether to execute the conditional handover as it is on the basis of the predicted reception quality (second reception quality, cell prediction result) of the target cell in a case where the configured event condition is fulfilled. As the cell prediction result, a cell prediction result after a predetermined time has elapsed from the time when the event condition is fulfilled is used. The predetermined time may be the same time as the TTT configured in the event condition, or may be a value designated by the base station apparatus 20.

The terminal apparatus 10 may determine, on the basis of the cell prediction result, not to perform the conditional handover in a case where a radio link failure is predicted after the conditional handover, more specifically, in a case where it is predicted that the reception quality of another neighboring cell exceeds that of the target cell in a short time after the handover to the target cell, in a case where the handover of the source cell is performed again after the handover to the target cell, in a case where the reception quality of the target cell falls below a predetermined value after a predetermined time, in a case where an event leaving condition of the target cell is satisfied, and in a case where a predicted stay time of the target cell after the handover is less than the predetermined time. Each parameter used for the above determination may be notified from the base station apparatus 20 to the terminal apparatus 10 in advance.

In a case of determining not to perform the conditional handover, the terminal apparatus 10 may transmit a measurement report message including the fulfilled measurement identifier to the base station apparatus 20. Alternatively, the terminal apparatus 10 may transmit another RRC message (for example, UE assistance information) including the information indicating that the conditional handover is not performed and the determination reason therefor.

As described above, according to the second embodiment, the terminal apparatus 10 and the base station apparatus 20 predict the reception quality of the cell using the trained model and perform the conditional handover based on the prediction result of the reception quality of the cell, so that the performance of the mobility control between the terminal apparatus 10 and the base station apparatus 20 can be improved.

Note that each of the above-described embodiments is for facilitating understanding of the present disclosure, and is not intended to limit the present disclosure. The present disclosure can be modified and improved without departing from the gist thereof, and the present disclosure includes equivalents thereof.

### Hardware Configurations of Apparatuses in Each Embodiment

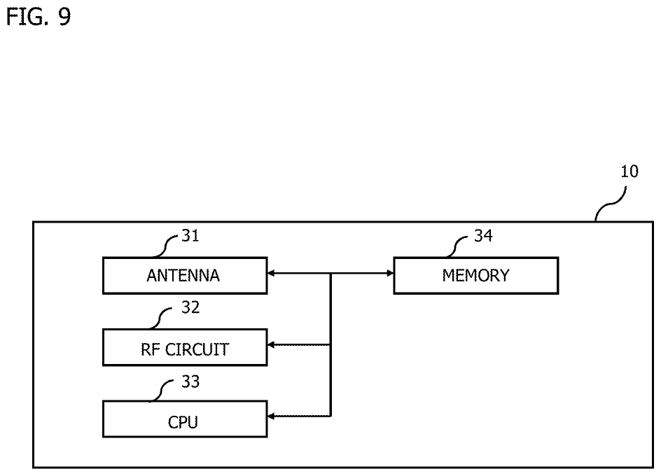

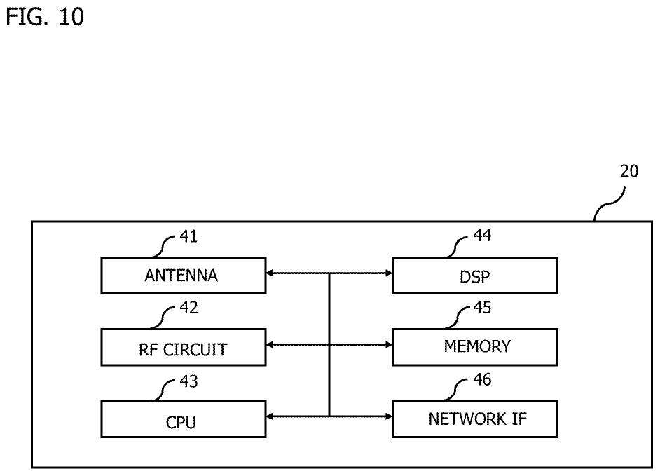

A hardware configuration of each apparatus in the radio communication system of each embodiment will be described with reference to FIGS. 9 and 10.

FIG. 9 is a diagram illustrating an example of a hardware configuration of the terminal apparatus 10. As illustrated in FIG. 9, the terminal apparatus 10 has, for example, a radio frequency (RF) circuit 32 including an antenna 31, a central processing unit (CPU) 33, and a memory 34 as hardware components. The terminal apparatus 10 may have a display apparatus such as a liquid crystal display (LCD) connected to the CPU 33. The memory 34 includes, for example, at least one of a random access memory (RAM) such as a synchronous dynamic random access memory (SDRAM), a read only memory (ROM), and a flash memory, and stores a program, control information, and a data signal.

The correspondence between the functional configuration of the terminal apparatus 10 illustrated in FIG. 2 and the hardware configuration of the terminal apparatus 10 illustrated in FIG. 9 will be described. The transmission/reception antenna unit 19, the transmission unit 17, and the reception unit 15 are realized by, for example, the RF circuit 32, or the antenna 31 and the RF circuit 32. The control unit 13 and the processing unit 11 are realized by, for example, the CPU 33, the memory 34, and a digital electronic circuit (not illustrated). Examples of the digital electronic circuit include an application specific integrated circuit (ASIC), a field programmable gate array (FPGA), and a large scale integration (LSI).

FIG. 10 is a diagram illustrating an example of a hardware configuration of the base station apparatus 20. As illustrated in FIG. 10, the base station apparatus 20 includes, for example, an RF circuit 42 including an antenna 41, a CPU 43, a DSP 44, a memory 45, and a network interface (IF) 46 as hardware components. The CPU 43 is connected via a bus so that input and output of various signals and data signals are possible. The memory 45 includes, for example, at least one of a RAM such as a SDRAM, a ROM, and a flash memory, and stores programs, control information, and data signals.

The correspondence between the functional configuration of the base station apparatus 20 illustrated in FIG. 3 and the hardware configuration of the base station apparatus 20 illustrated in FIG. 10 will be described. The transmission/reception antenna unit 29, the transmission unit 27, and the reception unit 25 are realized by, for example, the RF circuit 42, or the antenna 41 and the RF circuit 42. The control unit 23 and the processing unit 21 are realized by, for example, the CPU 43, the DSP 44, the memory 45, and a digital electronic circuit (not illustrated). Examples of the digital electronic circuit include an ASIC, an FPGA, and an LSI.

According to the above aspect, the performance of the mobility control between the terminal apparatus and the base station apparatus can be improved by predicting the reception quality of the cell using the trained model.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A terminal apparatus that communicates with a base station apparatus, the terminal apparatus comprising:
a receiver configured to receive, from the base station apparatus, information related to a measurement configuration including a measurement event for measuring reception quality of a cell and configuration information related to use of a cell prediction result;
a predictor configured to output a prediction of a variation in reception quality of the cell as a cell prediction result; and
a transmitter configured to report each of the measurement event, first reception quality actually measured regarding the measurement event, and second reception quality based on the cell prediction result to the base station apparatus on a basis of information indicating permission to use the cell prediction result.

2. The terminal apparatus according to claim 1, wherein
the predictor is further configured to acquire the second reception quality of the cell from a learning model by inputting the first reception quality of the cell to the learning model that has been machine-trained for predicting a variation in reception quality of the cell.

3. The terminal apparatus according to claim 2, wherein in a case where the learning model is available and the first reception quality satisfies a condition for fulfillment of the measurement event for a predetermined time, the transmitter transmits a measurement report message including each of the first reception quality and the second reception quality of the cell related to the measurement event, and
the second reception quality is a difference value from the first reception quality.

4. The terminal apparatus according to claim 3, wherein even in a case where the first reception quality satisfies a condition for fulfillment of the measurement event for a predetermined time, fulfillment of the measurement event is suppressed in a case where a handover to the cell is predicted to be inappropriate.

5. The terminal apparatus according to claim 2, wherein
in a case where the learning model is available and the second reception quality satisfies a condition for fulfillment of the measurement event for a predetermined time, the transmitter transmits a measurement report message including each of the first reception quality and the second reception quality of the cell related to the measurement event, and
the second reception quality is a difference value from the first reception quality.

6. The terminal apparatus according to claim 1, wherein in a case where a conditional handover configuration corresponding to the measurement event is configured, and the second reception quality in a measurement object cell of the conditional handover configuration satisfies a condition for fulfillment of the measurement event for a predetermined time, a conditional handover procedure corresponding to the measurement event is performed.

7. A base station apparatus that communicates with a terminal apparatus, the base station apparatus comprising:
a transmitter configured to transmit, to the terminal apparatus, information related to a measurement configuration including a measurement event for measuring reception quality of a cell and configuration information related to use of a cell prediction;
a predictor configured to perform control related to a prediction of a variation in the reception quality of the cell, the prediction being output by the terminal apparatus as a cell prediction result; and
a receiver configured to receive a measurement report message transmitted on a basis of information indicating permission to use the cell prediction result, the measurement report message including each of the measurement event, first reception quality regarding the measurement event, the first reception quality being actually measured by the terminal apparatus, and second reception quality based on the cell prediction result.

8. The base station apparatus according to claim 7, wherein the first reception quality of the cell is input to a trained learning model that has been machine-trained for predicting a variation in the reception quality of the cell, the learning model being included in the terminal apparatus, to acquire the second reception quality of the cell from the learning model.

9. The base station apparatus according to claim 7, wherein an evaluation parameter for evaluating a degree of deviation between the first reception quality actually measured by the terminal apparatus and the second reception quality based on the cell prediction result is configured in the terminal apparatus.

10. The base station apparatus according to claim 7, wherein a conditional handover configuration corresponding to the measurement event is configured in the terminal apparatus, and execution of the conditional handover procedure based on the cell prediction result is permitted.

11. A method of controlling a terminal apparatus that communicates with a base station apparatus, the method comprising:
receiving, from the base station apparatus, information related to a measurement configuration including a measurement event for measuring reception quality of a cell and configuration information related to use of a cell prediction;
outputting a prediction of a variation in the reception quality of the cell as a cell prediction result; and
reporting each of the measurement event, first reception quality actually measured regarding the measurement event, and second reception quality based on the cell prediction result to the base station apparatus on a basis of information indicating permission to use the cell prediction result.
